(19) United States
(12) Patent Application Publication
(10) Pub. No.: US 2006/0070697 A1
(43) Pub. Date: Apr. 6, 2006

(54) Method and apparatus for directing resin-impregnated tape

(75) Inventor: Klaus Hoffmann, Rockford, IL (US)

Correspondence Address: REINHART BOERNER VAN DEUREN LTD., 483 NORTH MULFORD ROAD, SUITE 7, ROCKFORD, IL, 61107, US

(73) Assignee: Ingersoll Machine Tools, Inc., Rockford, IL (US)

(21) Appl. No.: 11/232,689

(22) Filed: Sep. 22, 2005

Related U.S. Application Data
(60) Provisional application No. 60/612,402, filed on Sep. 23, 2004.

(51) Int. Cl. B32B 37/00

(52) U.S. Cl. 156/166; 156/441; 156/361

(57) ABSTRACT

A method and apparatus are provided for guiding and/or redirecting a filament tow or tape in an automated fiber placement process, through use of a gas bearing having a porous wall defining an internal guide, and/or a channel by means of which the tow or tape is routed and supported by a flow of pressurized gas, such as air or nitrogen, that is fed through the porous wall to create a gas bearing effect for supporting, guiding, and redirecting the tow or tape within the tubular bushing in such a manner that contact between the tow or tape. A porous section of the gas bearing may be constructed layer-by-layer by a process such as stereolithography.

### CROSS-REFERENCE TO RELATED PATENT APPLICATIONS

This patent application claims the benefit of U.S. Provisional Patent Application No. 60/612,402 filed Sep. 23, 2004, the disclosure of which is incorporated herein in its entirety by reference.

### FIELD OF THE INVENTION

This invention relates generally to the manufacture of articles from pre-impregnated composite materials, and more particularly to apparatuses and methods for performing automated lay-up of resin-impregnated tape or tows onto a mandrel, or onto other types of substrates, during the manufacture of articles using composite materials.

### BACKGROUND OF THE INVENTION

Automated fiber placement is a high-speed process in which a resin-impregnated tow or tape of fibrous material, such as fiberglass or carbon fiber impregnated with a partially cured polyester or epoxy resin, is laid down continuously over a mandrel or a substrate to form parts. Once the lay-up is completed, the resin is cured to complete fabrication of the part. Fiber placement is often used for parts having highly complex contours or angles, such as wing skin panels for fighter jets. Fiber placement is versatile, allowing breaks in the process and easy direction changes.

The fiber placement process automatically places multiple layers of pre-impregnated tows or tape of fibrous material onto a mandrel or a substrate at high speed, using a numerically controlled placement head to dispense, clamp, cut and restart the tow or tape periodically during placement. The fiber placement heads can be attached to a multi-axis, numerical controlled machine, so that placement of the tow or tape of fibrous material can be accurately controlled. It is also common practice to utilize fiber placement machinery that is capable of simultaneously laying multiple tows or strips of tape onto the mandrel or substrate. Some known machines, for example, will simultaneously lay thirty-two tows or strips of tape which are fed to the placement head from thirty-two separate rolls of resin-impregnated tows or tape. In order to facilitate application of the tow or tape, it is also common for the fiber placement machinery to include means for heating the resin-impregnated tow or tape.

In order to direct multiple tows or strips of tape to the laying heads from multiple rolls of tows or tape, it is necessary to provide redirect elements of the machine that can guide or re-direct the tows or tape through an angle changing by as much as forty degrees from orientation at which the tow or tape leaves its respective roll. In prior fiber placement machines, these redirect elements 100 have utilized pairs of rollers 102, mounted in a frame 104, for directing each of the tows or strips 106 of tape, as shown in FIGS. 1 and 2. Utilization of these rollers has proved to be problematic in that the resultant structure for providing two rollers to guide each of thirty-two tows or strips of tape is large, relatively complex and cumbersome. It is also somewhat difficult to load the multiple tows or strips of tape into such a multiple roller redirect structure.

During the fabrication of a part, using fiber placement, it is sometimes necessary to interrupt the fiber placement process while other operations are performed. Such interruptions can cause additional problems, because the pre-impregnated tows or tape will sometimes stick to the rollers, when they are not turning. If the tow or tape does stick to the rollers, when the fiber placement operation is resumed, one or more tows or strips of tape may adhere so tightly to the rollers that they will break, or the fibers of the tow or tape adhering to the rollers will separate, and thereby ruin the part, or undesirably add significant time, difficulty and cost to fabricating the part in the form of operations required to deal with the broken or separated tow or tape. Where heat is applied to the tow or tape, the tow or tape may be more prone to adhering to the rollers, when winding is interrupted, as a result of cooling of the resin that occurs while the tow or tape is in contact with the rollers when they are not turning.

It is desirable, therefore, to provide an improved method and an apparatus for redirecting single or multiple tows or strips of resin-impregnated tape during a fiber placement operation, in a manner that overcomes one or more of the problems described above.

### BRIEF SUMMARY OF THE INVENTION

The invention provides a method and apparatus for guiding and/or redirecting a tow or a tape of fibrous material in a fiber placement machine, through use of a gas bearing having an internal guide, and/or a channel for passage therethrough of a filament tow or tape of fibrous material.

An internal guide, according to the invention, may include be configured for feeding pressurized gas outward between the guide and an inside surface of a bend in one or more filament tows, for supporting the one of more filament tows in such a manner that the tows may be redirected by the apparatus. The internal guide may include porous or perforate portions having passageways therein for directing pressurized gas outward between the guide and the inside surface of the bend in one or more of the one or more filament tows. An internal guide, according to the invention may be configured for redirecting one or more of the one or more filament tows through an angle greater than 180 degrees.

The channel, in a gas bearing according to the invention, may fully or partially circumscribe the tow or tape, and may be formed by a wall which includes a perforate portion thereof, through which pressurized gas is supplied to the channel, for supporting the tow or tape within the channel.

It will also be recognized, by those having skill in the art, that the distinction between the terms “tow” and “tape” will be difficult to make in some cases, and particularly where very narrow strips of tape are utilized, the distinction between a tow and a tape is largely insignificant, with regard to understanding and practicing the invention. Accordingly, terms used for describing the specific form of the filaments or fibrous material to be guided, in accordance with the invention, such as tow, tape, and strips of tape, are meant to be substantially interchangeable, as used herein, and are not intended to limit the invention to the specific term (tow vs. tape, for example) used in the written description herein of the invention and exemplary embodiments thereof.

In one form of the invention, the tow or tape is routed through a body of a gas bearing including a porous wall defining a channel in the form of a bore, and a gas such as air or nitrogen is fed through the porous wall to create a gas bearing effect for supporting the tow or tape within the bore in such a manner that contact between the tow or tape and the wall of the bore is minimal. The body may take the form of a bushing having any tubular shape, including a right circular cylinder, and including a wall defining a channel in the form of the bore. The tow or tape may be impregnated with a resin. Where the resin is partially cured or left in a so-called B-stage, the tow or tape may be sticky, and need to be stored at cool temperatures, with heating of the tow or tape required for smooth winding of the tow or tape.

The bushing may be fabricated from porous forms of materials such as ceramic, sintered metal, carbon, or plastics such as UHMW polyethylene, ABS, HDPE, or LDPE. The bushing may be made impermeable to the passage of gas in areas where it is not desirable for the gas to escape, to provide for efficient and effective use of the gas for supporting the tow or tape. For example, in a ceramic bushing, it may be desirable to have the ends, or other portions of the bushing glazed. In other materials, coatings or impregnants may be selectively applied to form substantially impermeable segments of the bushing.

A bushing, according to the invention may also be constructed from a substantially non-porous material, which is fabricated or machined to provide orifices or other types of flow channels in or through the wall for directing pressurized gas into the bore.

In an apparatus, according to the invention, the choice of material will preferably include consideration of the performance of the apparatus in the event that the flow of gas is lost, i.e. how likely is it that the tow or tape would stick to elements of the gas bearing flow of gas to the bearing were to be interrupted.

According to one aspect of the invention, a body or bushing defining the channel may be formed at least partially through a process known in the industry as stereolithography, in which the body or bushing is at least partially constructed by sequentially building up thin layers of material, on top of each other, to form a structure which is inherently porous, even when otherwise substantially non-porous materials, such as ABS, HDPE, or LDPE, are utilized.

According to one aspect of the invention, one or more of the bushings may be mounted in a frame having an internal gas passageway that supplies pressurized air or another gas to an outer surface of the wall of each bushing. The gas pressure then forces the gas through the porous bushing for supporting the tow or tape within the bushing with minimal contact with the wall of the bushing. The gas may be heated or cooled to facilitate the fiber placement operation. The gas pressure may be sufficient to raise the tow or tape off of the inside surface of the wall, if there has been an interruption in the flow of gas through the bushing during operation of the fiber placement machine.

According to another aspect of the invention, the bushings are split into two parts and mounted in a frame having a frame section that can open, carrying one half of each bushing with it, to facilitate routing of the tow or tape through the bushings.

In some forms of the invention, a gas bearing may include a body having a wall defining a channel for passage of a filament tow therethrough.

Other aspects, objectives and advantages of the invention will become more apparent from the following description of the invention, in conjunction with the accompanying drawings.

### BRIEF DESCRIPTION OF THE DRAWINGS

FIGS. 1 and 2 are photographs of a prior tape redirect device having multiple pair or rollers mounted in for re-directing several strips of tape;

FIG. 3 is a perspective drawing of a first exemplary embodiment of the invention, having a tubular porous bushing for guiding and supporting a strip of tape;

FIG. 4 is an orthographic representation of a second exemplary embodiment of the invention, having a plurality of tubular porous bushings mounted in a frame.

FIG. 5 is an orthographic representation of a third embodiment of the invention having a plurality of bushings that are split into two parts and mounted in a frame having a frame section that can open, carrying one half or each bushing with it, to facilitate routing of the tape through the bushings.

FIG. 6 is a schematic representation of a fourth embodiment of the invention in the form of a tape winding apparatus, according to the invention, having a tape guide-and- redirect apparatus including one or more porous bushings for guiding and directing a tape onto a mandrel or substrate.

FIG. 7 is a perspective drawing of a fifth exemplary embodiment of the invention, bearing substantial similarity to the first exemplary embodiment shown in FIG. 3, having a body including a permeable tubular bushing formed by sequentially building up thin layers of material.

FIG. 8 is a perspective illustration of a sixth exemplary embodiment of the invention having a gas bearing including an internal guide for supporting, guiding, and redirecting a filament tow.

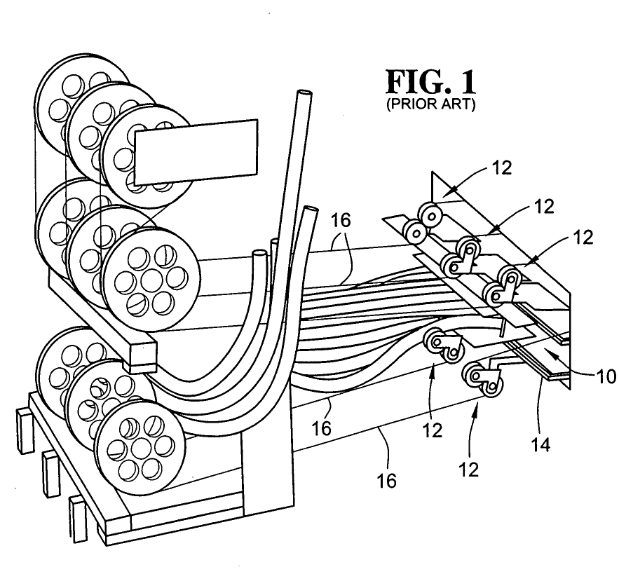

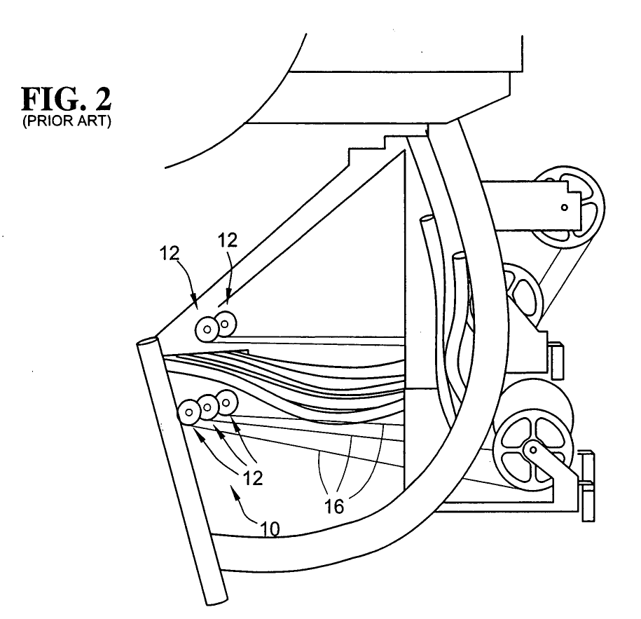

While the invention will be described in connection with certain preferred embodiments, there is no intent to limit it to those embodiments. On the contrary, the intent is to cover all alternatives, modifications and equivalents as included within the spirit and scope of the invention. The disclosure provided by all patents or other documents referenced herein or in the attachments is incorporated herein by reference.

### DESCRIPTION OF THE INVENTION

In the following description of exemplary embodiments of the invention, it is contemplated that references to methods and apparatuses for placing a tape, or strips of tape, of fibrous material are also applicable to methods and apparatuses for placing tows of fibrous material. As previously stated above, it will also be recognized, by those having skill in the art, that the distinction between the terms “tow” and “tape” is difficult to make in some cases, and particularly where very narrow strips of tape are utilized, the distinction between a tow and a tape becomes insignificant, with regards to general construction and operation of a fiber placement machine, or practice of a method, according to the invention.

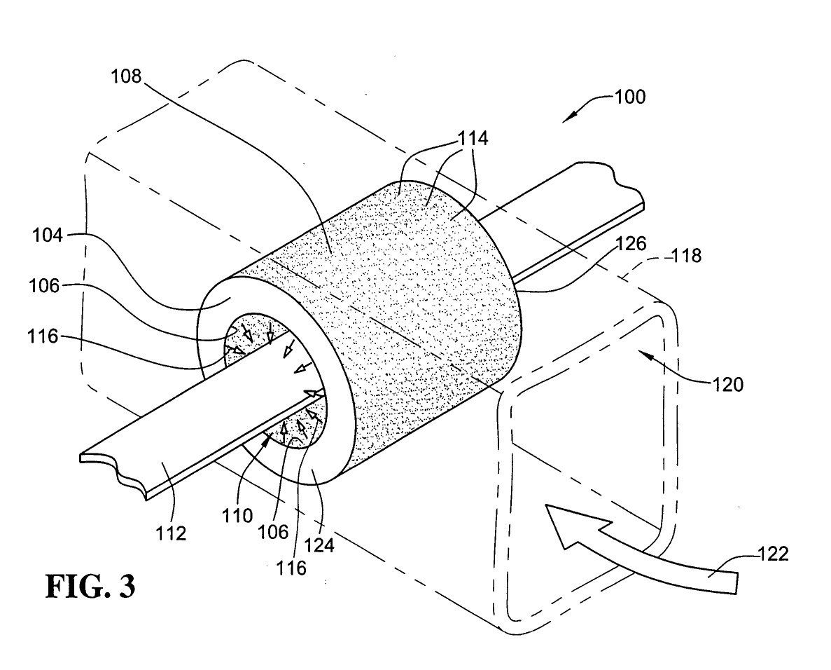

FIG. 3 shows a first exemplary embodiment of the invention, in the form of a tape guide-and- redirect apparatus 100, for a fiber placement apparatus. As shown in FIG. 3, the tape guide-and-redirect apparatus 100 of the first exemplary embodiment, includes a tubular bushing 102, of porous material, having a wall 104 defining an inner surface 106 and an outer surface 108 of the bushing 102. The inner surface 106 of the wall 104 of the bushing 102 defines a channel or bore 110 of the bushing 102, adapted for receiving and circumscribing a strip of tape 112. Preferably, the bore 110 is enough larger than the tape 112 that the tape 112 pass through the bore without touching the inner surface 106 of the bushing 102.

The bushing 102 is fabricated from a porous form of a material such as ceramic, sintered metal, carbon, or plastics such as UHMW polyethylene, ABS, HDPE, or LDPE, that provides small passageways 114 for a pressurized gas to flow through the wall 104 of the bushing 102 from the outer surface 108 to the inner surface 106 of the bushing 102. As gas flowing through the wall 104 exits the inner surface 106, as indicated by arrows 116, it lifts the tape 112 away from the inner surface 106 of the bushing 102 and acts as a gas bearing to support the tape 112 within the bore 110 without the necessity of having the tape 112 in contact with the inside surface 106 of the bushing.

By virtue of this arrangement, it will be understood that the tape 112 will not be able to stick to the bushing 102, so long as the gas is supporting the tape 112 in the bore 110 of the bushing 102. It is also preferable that the bushing 102 be constructed of a material that has an inherently low propensity to adhere to the tape, an/or that the inner surface 106 of the bushing 102 be configured and/or treated to have a low propensity of adherence of the tape 112.

One or more bushings 102, according to the invention, may be mounted in a frame 118, as shown in phantom lines in FIG. 3 for clarity of describing the bushing 102. The frame includes an inner flow channel 120 for supplying a flow of pressurized gas to the outer surface 108 of the bushing(s), as indicated in FIG. 3 by arrow 122. Certain portions of the bushing 102, such as the end surfaces 124, 126 of the bushing in the first exemplary embodiment, may be coated, glazed, impregnated, or otherwise treated to prevent leakage and for directing the gas into the bore 110 in a manner that promotes efficient and effective operation of the tape-guide and redirect apparatus 100, and in particular, effective and efficient guidance and support of the tape 112.

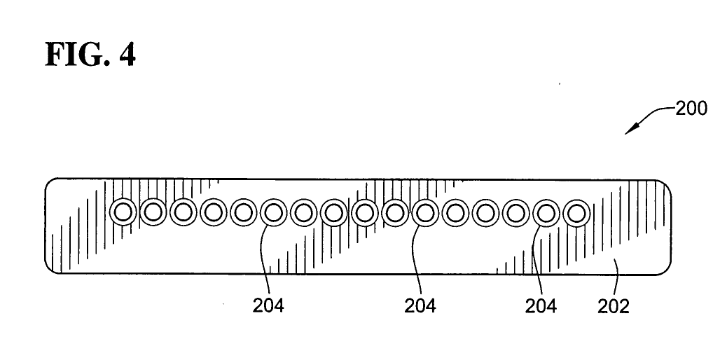

FIG. 4 shows a second exemplary embodiment of the invention, in the form of a tape guide-and-redirect apparatus 200 having a frame 202 holding a plurality of bushings 204, of the type described above in relation to the first exemplary embodiment. The frame 202 includes an internal gas passage (not shown) for supplying pressurized gas to the outer surface(s) of the bushing(s) 204, in the same manner as described above in relation to the first exemplary embodiment.

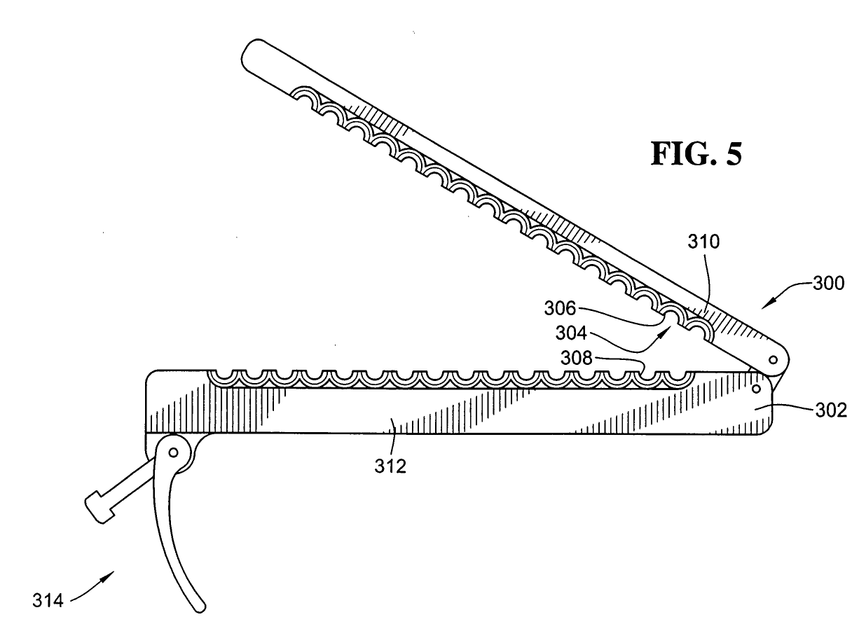

FIG. 5 shows a third exemplary embodiment of the invention, in the form of a tape guide-and-redirect apparatus 300 having a frame 302 holding a plurality of bushings 304, of the type described above in relation to the first exemplary embodiment. The frame 302 includes an internal gas passage (not shown) for supplying pressurized gas to the outer surface(s) of the bushing(s) 304, in the same manner as described above in relation to the first and second exemplary embodiments. In the embodiment shown in FIG. 5, however, the bushings 304 are split into first and second halves 306, 308, that are respectively mounted in a first segment 310 and a second segment 312 of the frame 302. The first and second frame segments 310, 312 are pivotably joined at one end so that the frame 302 and bushings 304 can be opened to facilitate loading strips of tape into all of the bushings 304. The other end of the frame 302 is equipped with a latch mechanism 314 for latching the frame 302 and bushings 304 in a closed position.

It will be noted that in the second and third exemplary embodiments 200, 300 of the invention, the multiple channels or bores 204, 304 extend substantially parallel to one another, and are arranged in a side-by-side relationship to one another to form a substantially planar array of the channels 204, 304. In other embodiments of the invention, however, the channels may be oriented substantially non-parallel to one another, and/or may be arranged in other than a planar side-by-side relationship.

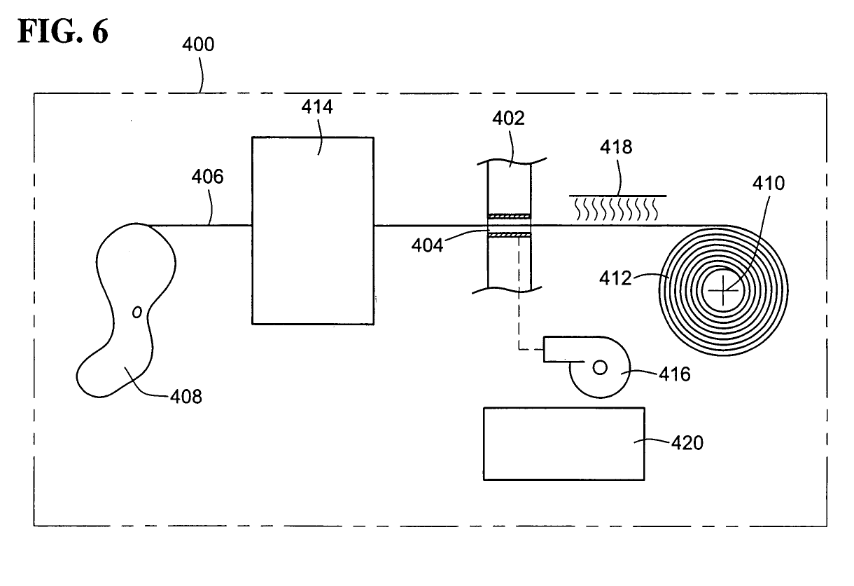

FIG. 6 is a schematic representation of a fourth exemplary embodiment of a fiber placement machine 400, according to the invention, having a tape guide-and-redirect apparatus 402 including one or more porous bushings 404 for guiding and directing a tape 406 onto a mandrel or substrate 408. It is contemplated that the fiber placement machine 400, according to the invention, may include any or all of the components of a tape winding apparatus, in addition to the bushing(s) 404. Such components may include, but are not limited to: one or more spools 410 for mounting and controlling one or more rolls 412 of the tape 404; a tape guiding head 414; a source of pressurized gas 416 operatively connected to the bushing(s) 404; heating or cooling elements 418; and a controller 420 for controlling operation of the fiber placement machine 400, or any portion thereof. It is contemplated, particularly where complex parts are to be made, that the fiber placement machine 400 may include a multi-axis, computer controlled head 414 and a mandrel 408 that can be moved in one or more axes.

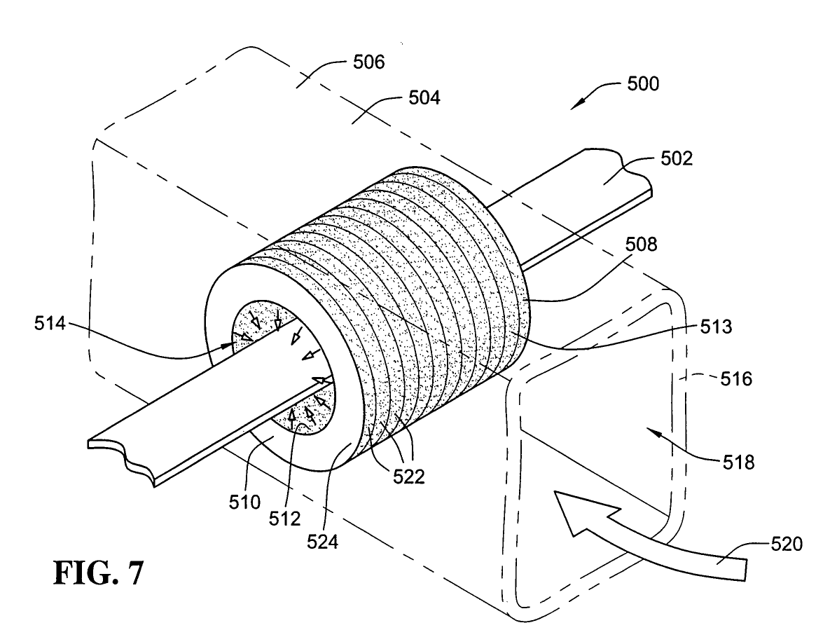

FIG. 7 shows a fifth exemplary embodiment of an apparatus 500, according to the invention, for guiding a filament tow 502 in a fiber placement machine. The apparatus 500 includes a gas bearing 504 having a body 506 which includes a tubular bushing 508, having a wall 510 defining an inner surface 512 and an outer surface 513 of the bushing 508. The inner surface 512 of the wall 510 of the bushing 508 defines a channel or bore 514 of the bushing 508, adapted for receiving and circumscribing the filament tow 502. Preferably, the bore 514 is enough larger than the tow 502 that the tow 502 passes through the bore 514 without touching the inner surface 512 of the bushing 508.

The body 506 of the gas bearing 504 also includes a frame portion 516. The frame portion 516 of the body 506 is joined to the bushing 508, and forms a gas plenum 518 for delivering pressurized gas to the outer surface 513 of the bushing 508, as indicated by arrow 520 in FIG. 7.

The portion of the body 506 forming the wall 510 of the tubular bushing 508, in the fifth exemplary embodiment 500, is constructed one slice (or layer) at a time by depositing sequential layers 522 of material, layer upon layer, as indicated by circumferential lines in FIG. 7, in such a manner that the wall 510 of the bushing 508 is permeable to the flow of pressurized gas into the bore 514 from the plenum 518.

In one form of the invention, a process known in the industry as stereolithography has been successfully utilized for constructing an embodiment of the invention, having multiple bushings 508 integrally formed with the frame portion 516 of the body 506, through the layer-upon-layer construction illustrated in FIG. 7. It will be understood that the layers indicated in FIG.7 have been shown with a considerably greater thickness than would typically be used, for purposes of illustration.

In stereolithography, a three-dimensional printing process is utilized for constructing a part. Typically a three-dimensional CAD model of the part to be produced is processed to create a file of the part in thin slices, and the part is constructed one slice (or layer) at a time (from a bottom to a top side of the part) by depositing layer upon layer of a material, such as a liquid form of a resin such as ABS, HDPE, or LDPE, that is hardened by a scanning laser which is programmed to “paint” each layer onto the surface of the liquid material as a support for the part is progressively drawn ever deeper below the surface of the liquid. Stereolithography, or similar processes, are widely utilized for rapid prototyping of parts which may be very complex.

Those having skill in the art will recognize that the structures created by stereolithography are typically inherently porous. While this is normally a drawback of this process, in that the structural strength of the part is somewhat compromised by the porosity, the astutely inventor recognized that such porosity could be used to significant advantage in constructing a gas bearing, according to the invention, in that the inherent porosity produced through stereolithography provides a convenient mechanism for directing pressurized gas into a channel of the gas bearing. Constructing the body of a gas bearing, according to the invention, by stereolithography also allows complex forms of the invention to be fabricated, having integrally joined walls defining channels, plenums, and frames or other structural elements, in a straightforward and cost effective manner. Areas of the body 506, such as the portions of the frame 516 forming the plenum 518, and the end surfaces 524 of the wall 510 of the tubular bushing 518, can be selectively coated or impregnated, in the manner described above with regard to previously described embodiments, to provide a body 506 having strategically placed permeable, and substantially impermeable, sections thereof.

It will be understood, however, that embodiments of the invention utilizing the layer-by-layer structure described above are not limited to construction by stereolithography. In some embodiments of the invention, other processes may be utilized for partially or completely constructing a body of an air bearing, according to the invention, by sequentially joining together successive layers in a manner that produces advantageous permeable areas in the body.

It will also be understood that, although the exemplary embodiments described and illustrated herein all show channels or bores that are substantially straight, in other embodiments of the invention this need not be the case. In other embodiments of the invention it may be desirable to have curved channels, for example.

It will be further understood that descriptive terms such as porous, perforate, and permeable, and the like, as used herein, are understood to be substantially interchangeable as descriptors of functional or structural properties required for practicing the invention. Although a given structure may be better described as porous, rather than perforate, for example, it is contemplated that the invention may be practiced in various forms with structures and materials that can be described by any or all of these terms. It is further contemplated that a gas bearing, according to the invention, may utilize structural elements other than a porous wall, such as grooves, orifices, holes, etc., to provide pressurized gas to a channel for supporting a filament tow within the channel.

It is contemplated that the guiding capabilities of an apparatus or method, according to the invention will vary with the configuration and operation of particular embodiments of the invention. In one embodiment, for example, it is contemplated that with a gas pressure of 4 bar (58 psi), in a bushing having an engagement length of 8.26 mm, a tape having a width of 3 mm can be redirected 20 degrees, with a bend radius of 23 mm at the bushing, while the tape is being held under a tensile force of 10 N. In other embodiments, it is contemplated that redirect angles smaller or larger than 20 degrees can be provided through practice of the invention.

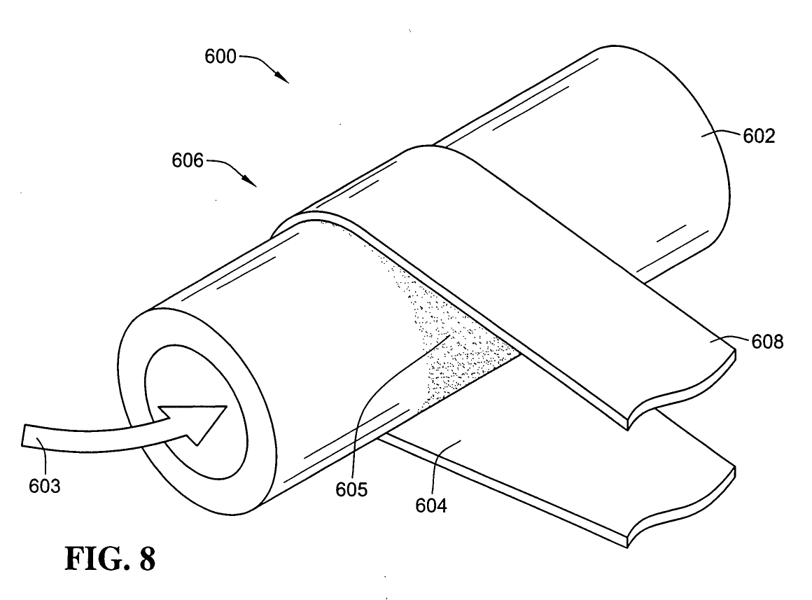

It is further contemplated, as shown in FIG. 8, that in some embodiments of the invention, a gas bearing 600 may include an internal guide 602, such as the hollow, shaft-like guide 602 shown in FIG. 8, feeding pressurized gas 603 out, through small passageways 605 in porous or perforate portions of the guide 602, between the guide 602 and an inside surface 604 of a bend 606 in one or more filament tows 608, for supporting the one of more filament tows 610 in such a manner that the tows 608 may be readily redirected through large angles, and even through angles greater than 180 degrees. Such internal guides may be used as the sole means of supporting and redirecting or guiding the tows, in some embodiments of the invention. In other embodiments of the invention, internal guides, according to the invention, may be used in conjunction with bearing elements defining a channel of the type described herein.

In some embodiments of the invention utilizing internal guides, the outer peripheral surface of the internal guide may include outwardly opening features (not shown, such as grooves or channels, for example, to facilitate operation of the gas bearing, and for directing and supporting of the tow. Although the exemplary embodiment of the internal guide 602 shown in FIG. 8 is a hollow cylindrical shaft, in other embodiments of the invention internal guides may take any other forms and/or shapes appropriate to the particular application.

An internal guide, according to the invention, may also be constructed in a layer-by-layer manner, by a process such as stereolithography, to provide a guide having porous or perforate portions thereof. Sections of the internal guide may also be coated, or impregnated, in the manner described above, to provide an internal guide having substantially imperforate portions thereof.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any element not expressly described herein as being essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intend for the invention to be practiced otherwise than as specifically described herein. Accordingly, this invention includes all modifications and equivalents of the subject matter recited or suggested herein as permitted by applicable law. Moreover, any combination of the above-described elements in all possible variations thereof is encompassed by the invention unless otherwise indicated herein or otherwise clearly contradicted by context.

What is claimed is:

1. An apparatus for guiding a filament tow during automated fiber placement, the apparatus comprising, a gas bearing providing a layer of pressurized gas for supporting and guiding the filament tow.

2. The apparatus of claim 1, wherein the gas bearing comprises an internal guide for feeding pressurized gas outward between the guide and an inside surface of a bend in one or more filament tows, for supporting the one of more filament tows in such a manner that the tows may be redirected by the apparatus.

3. The apparatus of claim 2, wherein the internal guide includes porous or perforate portions having passageways therein for directing pressurized gas outward between the guide and the inside surface of the bend in one or more of the one or more filament tows.

4. The apparatus of claim 2, wherein the internal guide is configured for redirecting one or more of the one or more filament tows through an angle greater than 180 degrees.

5. The apparatus of claim 1, wherein, the gas bearing defines a channel for passage therethrough of the filament tow.

6. The apparatus of claim 5, further comprising, a wall having a perforate portion thereof at least partially defining the channel of the gas bearing.

7. The apparatus of claim 6, wherein, the perforate portion of the wall is formed by stereolithography.

8. The apparatus of claim 6, wherein, the wall circumscribes the tow.

9. The apparatus of claim 6, further comprising, a plenum connected in operative fluid connection with the perforate portion of the wall for directing pressurized gas into the channel through the perforate portion of the wall.

10. The apparatus of claim 6, wherein, the wall is formed of a perforate material, with sections of the wall being made substantially imperforate through application of a coating to the substantially imperforate sections.

11. The apparatus of claim 10, wherein, the wall circumscribes the tow.

12. The apparatus of claim 11, wherein, the wall is formed by stereolithography.

13. The apparatus of claim 6, wherein, the wall is formed of a perforate material, with sections of the wall being made substantially imperforate through application of an impregnant material to the substantially imperforate sections.

14. The apparatus of claim 13, wherein, the wall circumscribes the tow.

15. The apparatus of claim 13 wherein, the wall is formed by stereolithography.

16. The apparatus of claim 6, further comprising, a tubular shaped guide including at least a portion of the perforate wall and defining the channel in the form of a bore adapted for circumscribing the tow when the tow is disposed in the bore.

17. The apparatus of claim 16; wherein, the tubular shaped guide is formed by stereolithography.

18. The apparatus of claim 15, wherein, the tubular shaped guide is selectively splitable, to facilitate disposing the tow in the bore.

19. The apparatus of claim 18, wherein, the splitable tubular shaped guide is formed by stereolithography.

20. A method for guiding a filament tow, during automated fiber placement, the method comprising, guiding the tow with a gas bearing defining a channel for passage therethrough of the filament tow.

21. The method of claim 20, wherein, the gas bearing includes a wall having a perforate portion thereof at least partially defining the channel of the gas bearing, and the method includes directing pressurized gas into the channel through the perforate portion of the wall.

22. An apparatus for guiding a plurality of filament tows during automated fiber placement, the apparatus comprising:
a gas bearing having a body including a wall defining multiple channels extending substantially parallel to one another for passage therethrough of the plurality of filament tows, with each of the channels being adapted for receiving a corresponding single one of the plurality of filament tows.

23. The apparatus of claim 22, wherein, the body is at least partially formed by stereolithography.

24. The apparatus of claim 23, wherein, the body includes perforate and imperforate portions thereof.

25. The apparatus of claim 22, further comprising, a plenum for directing pressurized gas to the channels.

26. The apparatus of claim 25, wherein:
the wall includes perforate portions thereof at least partially defining the channels;
the body further defines the plenum; and
the plenum is connected in operative fluid connection with the perforate portions of the wall for directing pressurized gas into the channels through the perforate portions of the wall.

27. The apparatus of claim 22, wherein, the multiple channels are substantially disposed in a side-by-side relationship to one another to form a substantially planar array of the channels.

28. The apparatus of claim 22, wherein, the channels each circumscribe the corresponding one of the tows, when the corresponding one of the tows is disposed in its respective channel.

29. The apparatus of claim 28, wherein, the body further comprises first and second mating parts thereof, each defining respective first and second peripheral surfaces of the plurality of channels.

30. The apparatus of claim 29, wherein, the first and second mating parts of the body are selectively separable from one another, to thereby facilitate routing of the tows through the channels.

31. A gas bearing apparatus, for supporting a supported element, the gas bearing comprising:
a body including a wall defining a channel for receiving the supported element;
the wall being constructed of multiple layers, joined one to another, layer upon layer, to form a porous structure for passage therethrough of pressurized gas for supporting the supported element in the channel.

32. A fiber placement machine, for guiding and/or redirecting a tow of fibrous material during automated fiber placement, the fiber placement machine comprising:
a supply spool for feeding out the tow;
a fiber placement head; and
a tape guide-and-redirect apparatus operatively disposed between the supply spool and the fiber placement head;
the tape guide-and-redirect apparatus including a gas bearing for guiding and/or redirecting the tow onto the substrate.

33. The fiber placement machine of claim 32, wherein the gas bearing comprises:
a body including a wall defining one or more channels for passage therethrough of the plurality of filament tows, with each one of the one or more channels being adapted for receiving a corresponding single filament tow;
the wall having a perforate portion thereof at least partially defining at least one of the one or more channels of the gas bearing.

34. The fiber placement machine of claim 33, further comprising a source of pressurized gas operatively connected to the body of the gas bearing for supplying gas to the channel through the perforate portion of the wall.
